(19) United States
(12) Patent Application Publication
(10) Pub. No.: US 2012/0096299 A1
(43) Pub. Date: Apr. 19, 2012

(54) UNIVERSAL SERIAL BUS DONGLE AND METHOD OF CONTROLLING POWER THEREOF

(75) Inventor: Dae Kwang KIM, Hwaseong-si (KR)

(73) Assignee: SAMSUNG ELECTRONICS CO. LTD., Suwon-si (KR)

(21) Appl. No.: 13/271,623

(22) Filed: Oct. 12, 2011

(30) Foreign Application Priority Data
Oct. 14, 2010 (KR) 10-2010-0100241

(51) Int. Cl. G06F 1/00

(52) U.S. Cl. 713/340

(57) ABSTRACT

An apparatus and method of controlling power of a Universal Serial Bus (USB) dongle are provided. The method includes detecting power consumption of the USB dongle when the USB dongle is connected with an apparatus to perform a communication function, determining whether the detected power consumption is equal to or greater than a maximum power, and lowering a data throughput when the detected power consumption is equal to or greater than the maximum power.

### PRIORITY

This application claims the benefit under 35 U.S.C. §119(a) of a Korean patent application filed on Oct. 14, 2010 in the Korean Intellectual Property Office and assigned Serial No. 10-2010-0100241, the entire disclosure of which is hereby incorporated by reference.

### BACKGROUND OF THE INVENTION

1. Field of the Invention

The present invention relates to a Universal Serial Bus (USB) dongle and a method of controlling the power thereof. More particularly, the present invention relates to a USB dongle, which is connected to an apparatus to transmit or receive data therebetween, and a method of controlling the power thereof.

2. Description of the Related Art

A Universal Serial Bus (USB) dongle is a device that is connected to an apparatus such as a computer to communicate data therebetween. For example, the USB dongle performs data communication with the apparatus or stores data received from the apparatus. The USB dongle includes a Long Term Evolution (LTE) USB dongle that can transmit and receive data through an LTE system. When the LTE USB dongle, which is currently being developed, performs a communication at a maximum power in a weak electric field, the temperature of a terminal to which the LTE USB dongle is connected is increased. Therefore, current consumption is increased due to a decrease in system efficiency of the LTE USB dongle. To address such problem, a battery can be built within the LTE USB dongle or the LTE USB dongle can be simultaneously connected to two USB ports by using a cable. However, placing a battery in the LTE USB dongle increases the size of the LTE USB as well as the cost thereof. Also, in a method of connecting the LTE USB dongle to two USB ports through a cable, the user is necessarily required to use the cable, which causes an inconvenience to the user. Further, the method of connecting the LTE USB dongle using the cable has a problem in that the cable cannot be used when the terminal, e.g., the computer, does not have a sufficient number of the USB ports. Accordingly, there is a need for an apparatus and method for controlling the power of a USB dongle.

### SUMMARY OF THE INVENTION

Aspects of the present invention are to address at least the above-mentioned problems and/or disadvantages and to provide at least the advantages described below. Accordingly, an aspect of the present invention to provide a terminal including a Universal Serial Bus (USB) dongle and a method of controlling the power thereof.

In accordance with an aspect of the present invention, a method of controlling a power of a USB dongle is provided. The method includes detecting power consumption of the USB dongle when the USB dongle is connected with an apparatus to perform a communication function, determining whether the detected power consumption is equal to or greater than a maximum power, and lowering a data throughput when the detected power consumption is equal to or greater than the maximum power.

In accordance with another aspect of the present invention, a USB dongle is provided, The dongle includes an external apparatus connection unit configured to connect to an apparatus to perform a communication function, a power detection unit configured to detect power consumption when connected to the apparatus through the external apparatus connection unit, and a control unit configured to determine whether the detected power consumption is equal to or greater than a maximum power and configured to reduce a data throughput when the detected power is equal to or greater than the maximum power.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will be more apparent from the following description taken in conjunction with the accompanying drawings, in which:

FIG. 1 illustrates a data communication system according to an exemplary embodiment of the present invention;

FIG. 2 illustrates a configuration of a Universal Serial Bus (USB) dongle according to an exemplary embodiment of the present invention;

FIG. 3 illustrates a power control method according to an exemplary embodiment of the present invention; and

FIG. 4 illustrates power consumption according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for the sake of clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

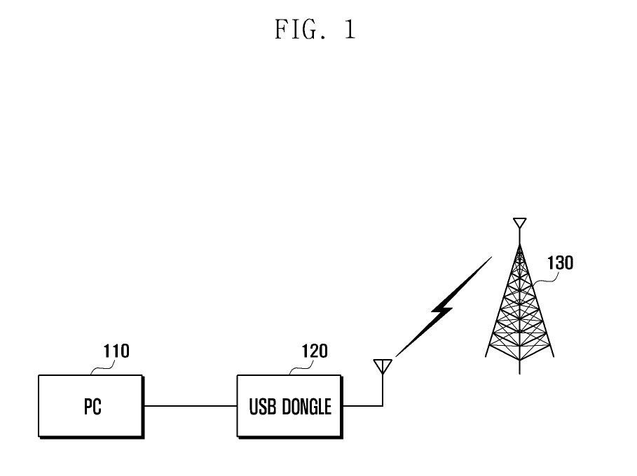

FIG. 1 illustrates a data communication system according to an exemplary embodiment of the present invention.

Referring to FIG. 1, the data communication system includes an apparatus 110, a Universal Serial Bus (USB) dongle 120, and a base station 130.

The apparatus 110 refers to an information processing apparatus that can process various data and may be implemented as a computer, a laptop, a portable terminal, a Portable Multimedia Player (PMP), and the like. As illustrated in FIG. 1, the apparatus 110 can be, for example, a Personal Computer (PC). Here, the apparatus 110 is connected to a network through a wired or wireless Local Area Network (LAN) or wirelessly connected to another apparatus or the base station 130 through the USB dongle 120, to transmit or receive data. A communication function that can be performed by the apparatus 110 includes a call function for transmitting or receiving voice data, a video call function for transmitting or receiving video data and voice data, a multimedia data communication function for transmitting or receiving multimedia data such as, for example, an image, a document, a video, and the like, and other communication functions.

The USB dongle 120 is a device that is mounted to the apparatus 110 to provide the apparatus 110 with data received externally or to transmit data received from the apparatus 110. Here, the USB dongle 120 is described as a Long Term Evolution (LTE) terminal that is connected to the apparatus 110 to enable a communication between the base station 130 and the apparatus 110. However, the present invention is not limited to this. Namely, the USB dongle 120 can include any type of USB dongle that can be connected to the apparatus 110 to perform a communication or other function. For example, a wireless LAN USB dongle for Internet connection, a USB dongle for providing Bluetooth capabilities, or a USB dongle for providing other services or capabilities can be included.

The base station 130 performs communication with the apparatus 110 through the USB dongle 120. Here, the base station 130 can control the strength of a signal transmitted to the apparatus 110 based on a data throughput transmitted from the USB dongle 120. Also, the base station 130 can perform a handover depending on the data throughput transmitted from the USB dongle 120.

Although it is described that the USB dongle 120 performs the communication between the base station 130 and the apparatus 110, the present invention is not limited to this exemplary embodiment. In other words, the USB dongle 120 may perform a communication between a network and the apparatus 110 or performs a communication between the apparatus 110 and another apparatus (not shown).

In order to prevent damage to the apparatus 110 that can be caused by the power consumption of the USB dongle 120, the power consumption of the USB dongle 120 is limited to a certain level. In an exemplary implementation, the USB dongle 120 detects the power consumption at and after a point of time when the USB dongle 120 is connected to the apparatus 110 and, when the power consumption is equal to or greater than the certain level, adjusts the data throughput thereof to control the power consumption.

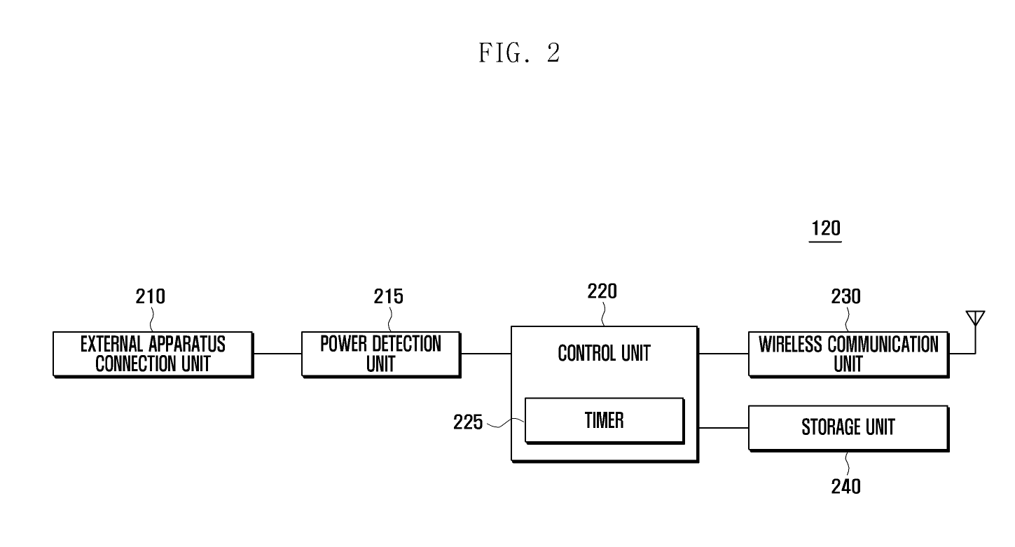

FIG. 2 illustrates a configuration of a USB dongle according to an exemplary embodiment of the present invention.

Referring to FIG. 2, the USB dongle includes an external apparatus connection unit 210, a power detection unit 215, a control unit 220, a wireless communication unit 230, and a storage unit 240.

The external apparatus connection unit 210 is connected to an apparatus through a cable or a USB connection port. Here, the external apparatus connection unit 210 provides the control unit 220 with data sent from the apparatus. Also, the external apparatus connection unit 210 can provide a power unit (not shown) with power received from the apparatus. The power unit can provide power to all elements of the USB dongle.

The power detection unit 215 detects power consumption of the USB dongle at and after a point of time when the USB dongle is connected to the apparatus through the external apparatus connection unit 210 under the control of the control unit 220 and transmits the detected power consumption to the control unit 220.

The control unit 220 controls an overall operation and a state of the elements of the USB dongle. Here, the control unit 220 detects the power consumption through the power detection unit 215, when connected to the apparatus through the external apparatus connection unit 210. Also, the control unit 220 can reduce the power consumption by controlling the data throughput when the power consumption is equal to or greater than a preset maximum power. To this end, the control unit 220 includes a timer 225.

When the power consumption is equal to or greater than the preset maximum power, the control unit 220 drives the timer 225. Also, the control unit 220 detects the power consumption through the power detection unit 215 for a preset threshold time period. The control unit 220 also controls the data throughput depending on the power consumption measured over the preset threshold time. Specifically, the control unit 220 can reduce the data throughput when the power consumption is maintained at a level equal to or greater than the maximum power. Here, the data throughput can be lowered sequentially or lowered to a certain level that is predefined per level of the power consumption.

The control unit 220 repeats the above process until a connection to the apparatus is released. Specifically, the control unit 220 can sequentially reduce the data throughput until the power consumption is lower than the maximum power. Here, the data throughput is considered to include a speed at which the data received from the apparatus is transmitted to a base station, a speed at which a signal from the base station is received to be sent to the apparatus, and a strength of transmission power for transmitting a signal to the base station in order to perform the communication function. Also, the USB dongle transmits information about the data throughput that can be handled by the USB dongle to the base station. Accordingly, the base station detects the data throughput and determines to perform the handover or controls a transmission signal.

The wireless communication unit 230 performs communication with the base station under the control of the control unit 220. Here, the wireless communication unit 230 can transmit the data sent from the apparatus to the base station or transmit the data received from the base station to the control unit 220, under the control of the control unit 220.

The storage unit 240 can store various data generated according to a function performed by the USB dongle. Here, the storage unit 240 stores the information about the data throughput that is adjusted according to the power consumption. Specifically, the storage unit 240 can store information of the data throughput determined for each level of power consumption. Also, the storage unit 240 can store information about a degree of reduction in the data throughput that is implemented each time the power consumption is equal to or greater than the maximum power.

For example, when the data throughput is controlled according to the measured power consumption, the data throughput can be set as 1 Mbps when the power consumption is 700 mA and set as 0.7 Mbps when the power consumption is 600 mA. Alternatively, when the power consumption is measured to be equal to or greater than the maximum power, the data throughput can be sequentially adjusted to be lower by 0.2 Mbps. Here, the above examples are given for illustrative purposes to explain a process of adjusting the data throughput according to the power consumption and should not be construed as limiting the present invention. Namely, the process of adjusting the data throughput can be set differently depending on a communication environment of the USB dongle, a manufacturer setting, a user's choice, and the like.

The USB dongle having the above configuration detects the power consumption at and after a point of time when the USB dongle is connected to the apparatus to determine whether the detected power consumption is equal to or greater than the preset maximum power. If the power consumption is equal to or greater than the maximum power, the USB dongle controls the data throughput until the power consumption of the USB dongle becomes lower than the maximum power. Namely, the USB dongle sequentially lowers the data throughput until the power consumption is lower than the maximum power. Here, the USB dongle determines whether the power consumption is maintained during a predetermined period of time and controls the data throughput when the power consumption is maintained during the predetermined period of time. However, if the power consumption is not maintained during the predetermined period of time, the USB dongle maintains an initial data throughput.

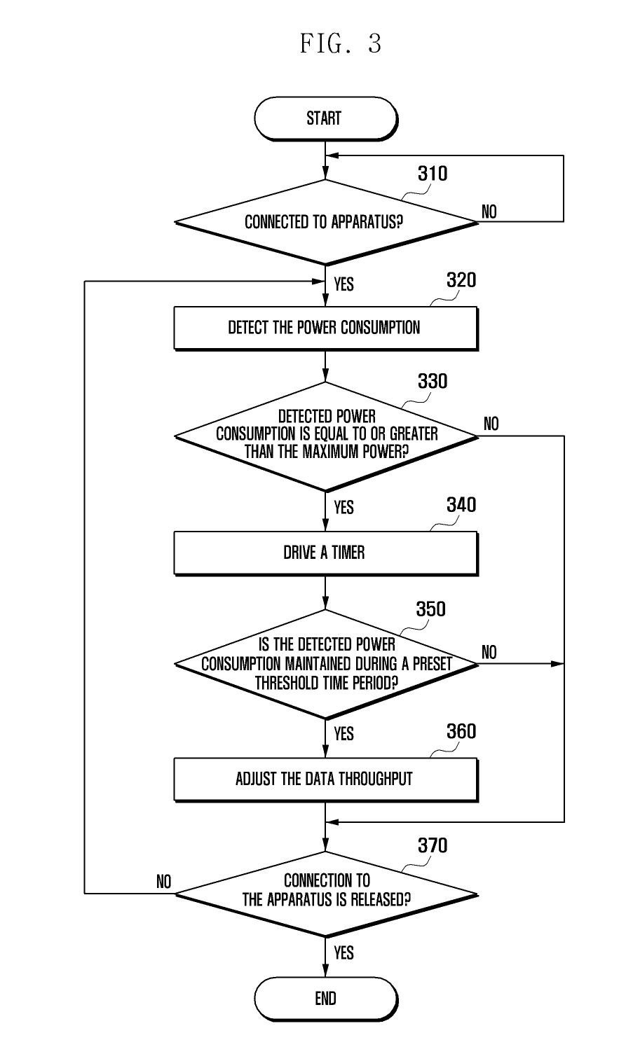

FIG. 3 illustrates a power control method according to an exemplary embodiment of the present invention.

Referring to FIG. 3, the USB dongle determines whether the USB dongle is connected to an apparatus in step 310. In an exemplary implementation, the USB dongle detects connection to an apparatus through an external apparatus connection unit. When it is determined in step 310 that the USB dongle is connected with the apparatus, the USB dongle detects the power consumption in step 320. In step 330, the USB dongle determines whether the detected power is equal to or greater than a preset maximum power. Here, the maximum power can be set as 500 mA according to a current standard USB specification. However, the present invention is not limited to this. In other words, the maximum power can be modified according to a user setting, a maximum data throughput that can be handled by the USB dongle, or other requirements.

If it is determined in step 330 that the detected power is not equal to or greater than the preset maximum power, the USB dongle proceeds to step 370. On the other hand, if it is determined in step 330 that the detected power is equal to or greater than the preset maximum power, the USB dongle drives a timer in step 340. In step 350, the USB dongle determines whether the detected power is maintained during a threshold time period. To determine whether the detected power is maintained during the threshold time period, the following exemplary method can be used. For example, after the timer is operated during the preset threshold time period, the USB dongle terminates the operation of the timer and again detects the power consumption. Alternatively, the USB dongle constantly identifies the power consumption over the threshold time period during which the timer is operated. In an exemplary implementation, the threshold time period can be set as one second or can be set as shorter or longer than one second depending on the user setting or the manufacturer setting.

If it is determined in step 350 that the detected power is maintained during the threshold time period, the USB dongle adjusts the data throughput in step 360. On the other hand, if it is determined in step 350 that the detected power is not maintained during the threshold time period, the USB dongle proceeds to step 370. In step 370, the USB dongle determines whether a connection with the apparatus 110 is released. If it is determined in step 370 that the connection with the apparatus is not released, the USB dongle returns to step 320. Alternatively, if it is determined in step 370 that the connection with the apparatus is released, the USB dongle ends the process of the exemplary embodiment.

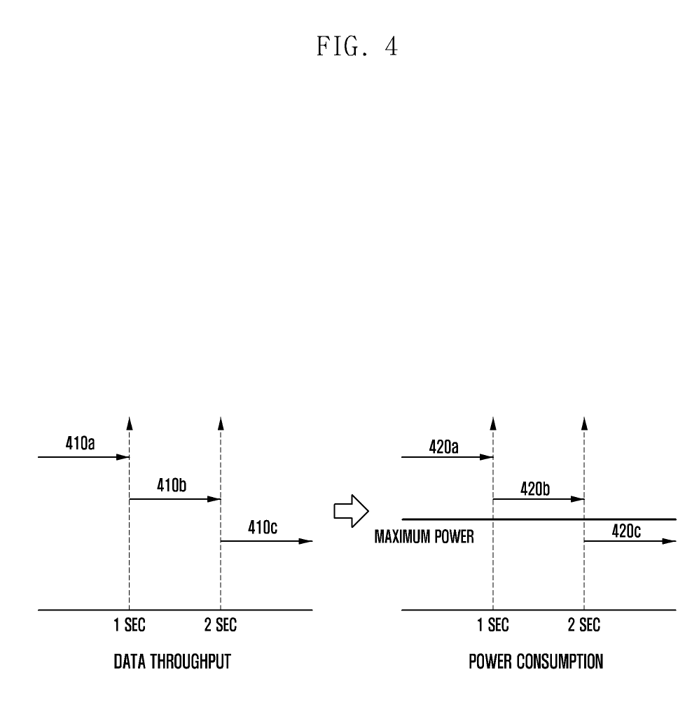

FIG. 4 illustrates power consumption according to an exemplary embodiment of the present invention.

Referring to FIG. 4, it is assumed that the data throughput is at a first stage 410a that requires a first power consumption level 420a. If the first power consumption 420a is maintained at a preset level of power consumption or a higher level for a predetermined threshold time period, e.g., one second, the USB dongle switches to the data throughput at a second stage 410b. The power consumption of the USB dongle is then lowered to a second power consumption level 420b.

Next, the USB dongle 120 determines whether the second power consumption 420b is maintained at a preset level of power consumption or a higher level for a predetermined threshold time period, e.g., one second. If the second power consumption 420b is maintained for one second, the USB dongle lowers the data throughput to a third level 410c. The power consumption of the USB dongle is then measured at a third power consumption level 420c.

In the above description, an exemplary method of reducing the power consumption of the USB dongle, which is an LTE terminal, by lowering the data throughput when the power consumption is equal to or greater than the maximum power was illustrated. In another exemplary embodiment, it is possible to increase the power consumption of the USB dongle up to a level of the maximum power by increasing the data throughput, when the power consumption is lower than the maximum power. Specifically, the USB dongle detects the power consumption at and after a point of time when the USB dongle is connected to a terminal. If the detected power consumption is less than the preset maximum power, the USB dongle increases a current data throughput to a next level. Therefore, by adjusting the data processing according to the power consumption of the USB dongle, the power consumption may not exceed the preset maximum power.

Exemplary embodiments of the present invention obviate a need to employ a battery within the LTE USB dongle to avoid the deterioration of the function of the LTE USB dongle caused by the power consumption thereof. Also, the user can use the LTE USB dongle without connecting the LTE USB to at least two USB ports by using a cable.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of controlling power of a Universal Serial Bus (USB) dongle, the method comprising:
detecting power consumption of the USB dongle when the USB dongle is connected with an apparatus to perform a communication function;
determining whether the detected power consumption is equal to or greater than a maximum power; and
lowering a data throughput when the detected power consumption is equal to or greater than the maximum power.

2. The method according to claim 1, wherein the lowering of the data throughput comprises:
determining whether the detected power consumption is maintained for a threshold time period; and
reducing the data throughput when the detected power consumption is maintained for the threshold time period.

3. The method according to claim 2, wherein the reducing of the data throughput comprises:
sequentially reducing the data throughput.

4. The method according to claim 1, wherein the USB dongle is connected to the apparatus to perform a Long Term Evolution communication function.

5. The method according to claim 1, wherein the USB dongle is connected to the apparatus to perform a Wireless Local Area Network communication function.

6. The method according to claim 1, wherein the USB dongle is connected to the apparatus to perform a Bluetooth communication function.

7. The method according to claim 1, further comprising:
transmitting information regarding the data throughput capability of the USB dongle.

8. The method according to claim 1, further comprising:
storing information regarding an amount of data throughput that should be lowered when the detected power consumption is equal to or greater than the maximum power.

9. A Universal Serial Bus (USB) dongle comprising:
an external apparatus connection unit configured to connect to an apparatus to perform a communication function;
a power detection unit configured to detect power consumption when connected to the apparatus through the external apparatus connection unit; and
a control unit configured to determine whether the detected power consumption is equal to or greater than a maximum power and configured to reduce a data throughput when the detected power is equal to or greater than the maximum power.

10. The USB dongle according to claim 9, wherein the control unit is configured to determine whether the detected power consumption is maintained during a threshold time period and configured to reduce the data throughput when the detected power consumption is maintained during the threshold time period.

11. The USB dongle according to claim 10, wherein the control unit is configured to sequentially reduce the data throughput.

12. The USB dongle according to claim 9, wherein the USB dongle is connected to the apparatus to perform a Long Term Evolution communication function.

13. The USB dongle according to claim 9, wherein the USB dongle is connected to the apparatus to perform a Wireless Local Area Network communication function.

14. The USB dongle according to claim 9, wherein the USB dongle is connected to the apparatus to perform a Bluetooth communication function.

15. The USB dongle according to claim 9, further comprising:
a wireless communication unit configured to transmit information regarding the data throughput capability of the USB dongle.

16. The USB dongle according to claim 9, further comprising:
a storage unit for storing information regarding an amount of data throughput that should be lowered when the detected power consumption is equal to or greater than the maximum power.
